(19) United States
(12) Patent Application Publication
(10) Pub. No.: US 2025/0139567 A1
(43) Pub. Date: May 1, 2025

(54) COORDINATION OF GOODS DELIVERY

(71) Applicant: EgerDrivers, Inc., DOUGLASVILLE, GA (US)

(72) Inventor: DAVID BRUCE EGER, DOUGLASVILLE, GA (US)

(73) Assignee: EgerDrivers, Inc., DOUGLASVILLE, GA (US)

(21) Appl. No.: 18/962,625

(22) Filed: Nov. 27, 2024

Related U.S. Application Data
(63) Continuation of application No. 17/555,946, filed on Dec. 20, 2021, now abandoned.
(60) Provisional application No. 63/127,952, filed on Dec. 18, 2020.

(51) Int. Cl. G06Q 10/083; G01C 21/34; G06Q 20/40

(52) U.S. Cl. CPC G06Q 10/083; G01C 21/3438; G06Q 20/401

(57) ABSTRACT

A system includes one or more processing devices and at least one memory on which are stored instructions that, when executed by the one or more processing devices, enable the one or more processing devices to perform a method of facilitating delivery of an item from a source destination to a target destination. The method includes the steps of receiving a delivery-route assignment request from a first user device associated with a producer, transmitting the request to one or more vehicle drivers, receiving an acceptance of the request from a second user device associated with a vehicle driver, receiving a first signal indicating that the vehicle driver is a predetermined first distance from the source destination, receiving a second signal indicating that the vehicle driver is a predetermined distance from the target destination, and in response to receiving the second signal, authorizing a payment to the vehicle driver.

### PRIORITY CLAIM

This application is a Continuation of U.S. patent application Ser. No. 17/555,946 filed Dec. 20, 2021, which application claims priority from U.S. Provisional Application Ser. No. 63/127,952 filed Dec. 18, 2020, the entirety of which is hereby incorporated by reference as if fully set forth herein.

### BACKGROUND

Goods providers, such as truckers, often require the services of vehicle drivers to execute shipment of such goods from a first location to a second location. Traditional methods of identifying qualified drivers can be unreliable and excessively time-consuming. What is needed is a more-efficient approach to facilitating such provider-driver arrangements.

### BRIEF DESCRIPTION OF THE DRAWING FIGURES

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 illustrates a process for route tracking and logging flow from the point of view of the Driver according to an embodiment of the invention; and

FIG. 4 illustrates a process for route tracking and logging flow from the point of view of the Provider according to an embodiment of the invention.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be described in the general context of computer-executable instructions, such as program modules, being executed by a processing device having specialized functionality and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

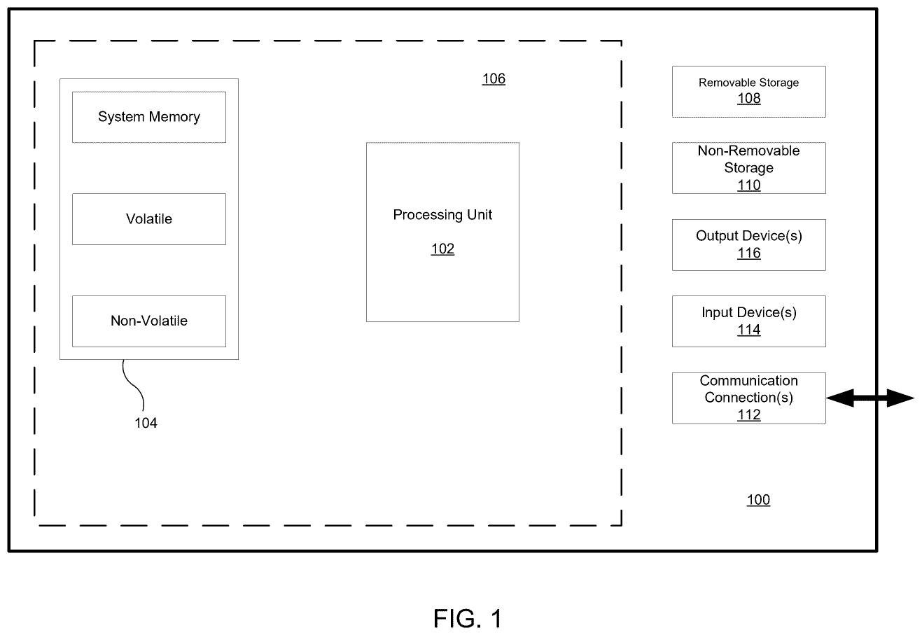

With reference to FIG. 1, an exemplary system for implementing an embodiment of the invention includes a computing device, such as computing device 100, which, in an embodiment, is or includes a smartphone. The computing device 100 typically includes at least one processing unit 102 and memory 104.

Depending on the exact configuration and type of computing device, memory 104 may be volatile (such as random-access memory (RAM)), nonvolatile (such as read-only memory (ROM), flash memory, etc.) or some combination of the two. This most basic configuration is illustrated in FIG. 1 by dashed line 106.

Additionally, the device 100 may have additional features, aspects, and functionality. For example, the device 100 may include additional storage (removable and/or non-removable) which may take the form of, but is not limited to, magnetic or optical disks or tapes. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

The device 100 may also include a communications connection 112 that allows the device to communicate with other devices. The communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, the communication media includes wired media such as a wired network or direct-wired connection, and wireless media such as acoustic, radio-frequency (RF), infrared, cellular and other wireless media. The term computer-readable media as used herein includes both storage media and communication media.

The device 100 may also have an input device 114 such as keyboard, mouse, pen, voice-input device, touch-input device, etc. Further, an output device 116 such as a display, speakers, printer, etc. may also be included. Additional input devices 114 and output devices 116 may be included depending on a desired functionality of the device 100.

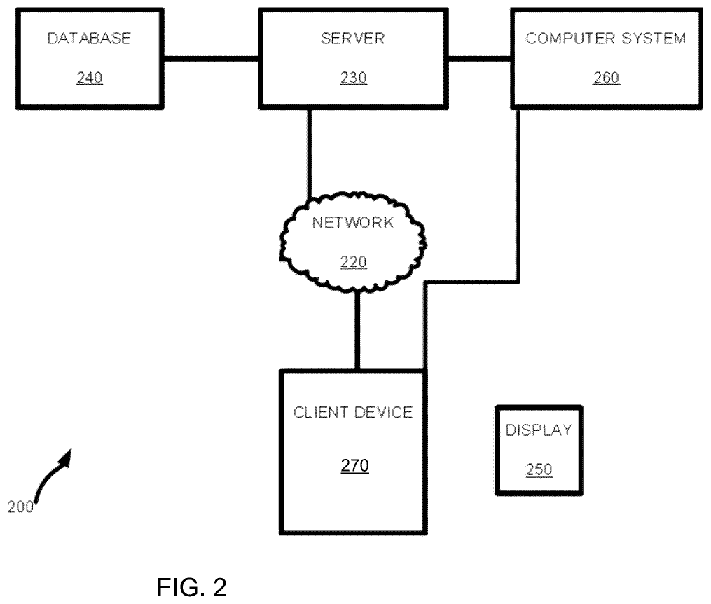

Referring now to FIG. 2, an embodiment of the present invention may take the form, and/or may be implemented using one or more elements, of an exemplary computer network system 200 that, in an embodiment, includes a server 230, database 240 and computer system 260. The system 200 may communicate with an electronic client device 270, such as a personal computer or workstation, virtual-reality (VR) image-capturing device (camera), tablet and/or smartphone, that is linked via a communication medium, such as a network 220 (e.g., the Internet, cellular network, etc.), to one or more electronic devices or systems, such as server 230. The server 230 may further be coupled, or otherwise have access, to a database 240 and a computer system 260. Although the embodiment illustrated in FIG. 2 includes one server 230 coupled to one client device 270 via the network 220, it should be recognized that embodiments of the invention may be implemented using one or more such client devices coupled to one or more such servers.

The client device 270 and the server 230 may include all or fewer than all of the features associated with the device 100 illustrated in and discussed with reference to FIG. 1. The client device 270 includes or is otherwise coupled to a computer screen or display 250. The client device 270 may be used for various purposes such as network- and local-computing processes.

The client device 270 is linked via the network 220 to server 230 so that computer programs, such as, for example, a short message service (SMS) application, running on the client device 270 can cooperate in two-way communication with server 230. The server 230 may be coupled to database 240 to retrieve information therefrom and to store information thereto. Database 240 may have stored therein data (not shown) that can be used by the server 230 and/or client device 270 to enable performance of various aspects of embodiments of the invention. Additionally, the server 230 may be coupled to the computer system 260 in a manner allowing the server to delegate certain processing functions to the computer system. In an embodiment, most or all of the functionality described herein may be implemented in a desktop or smartphone application that may include one or more executable modules. In an embodiment, the client device 270 may bypass network 220 and communicate directly with computer system 260.

An embodiment provides an approach for allowing Providers (i.e., users requiring help completing product-delivery routes) and Drivers (i.e., users completing Provider routes for compensation) to connect and exchange payment for miles driven.

In an embodiment, Providers and Drivers may have separate applications, but a user can register for both types of accounts. The Provider application allows users to submit requests for nearby Drivers to complete product-delivery routes. This is useful in that it allows Providers to complete routes in a timely manner and get more done in less time, unrestricted by electronic logging device (ELD) limitations.

Providers submit requests and are notified when a Driver accepts the request. Upon acceptance, Providers and Drivers can track Driver location/distance via the application, and the route begins once the Driver arrives at the Provider's location for pickup of the product(s) to be delivered and, perhaps, to assume possession of a vehicle of Provider to be used to deliver the product(s). The Driver may identify the Provider's vehicle via the application. Once the drive begins with the Driver commencing the route in the Provider's or other vehicle, route data (e.g., chronological location, time, and mileage) are stored to the database 240 and recorded to both users' route histories, accessible via one or more application interfaces for both users. The route is completed once one or more of the users' devices recognize the Driver having reached the final delivery destination. The route may also be terminated in the event of an emergency; the application includes an easy-to-access emergency call functionality which clearly indicates that the purpose is to alert local authorities. Upon completion of the route, payment is automatically calculated, charged to the Provider, and disbursed to the Driver and, in an embodiment, to an administrator of the user applications via, for example, the Stripe API.

The Driver application notifies Drivers of requests submitted by Providers within a predetermined distance of the Driver. In an embodiment, this predetermined distance can be set by the Driver using the Driver application. Route information can be stored in the same way that information is stored via the Provider application; however, the Drivers' interface focuses on information specific to them, including payout, profile, and similar information.

Providers may, using the Provider application, rate their experience with Drivers, allowing others to make informed decisions about whether to hire specific Drivers.

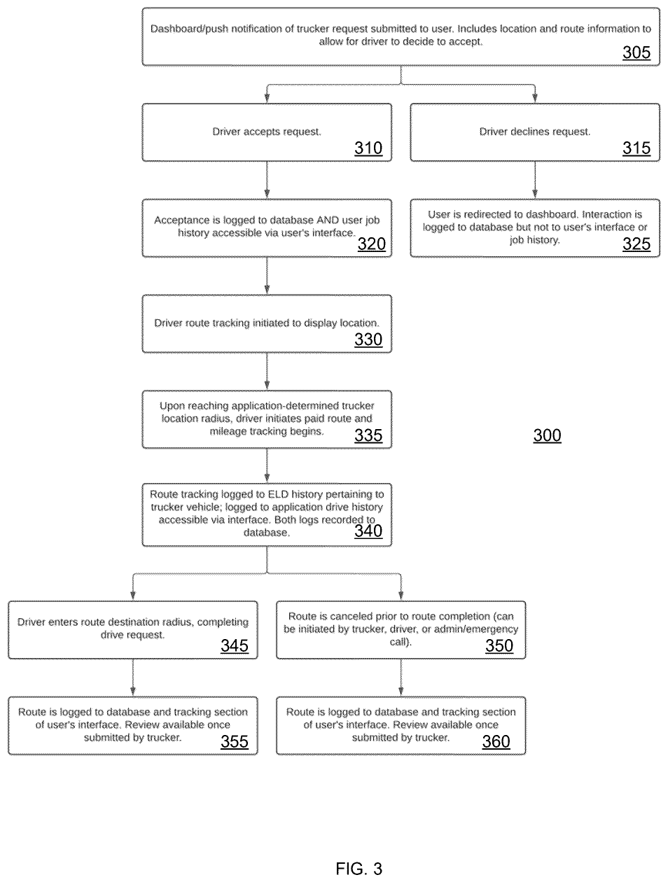

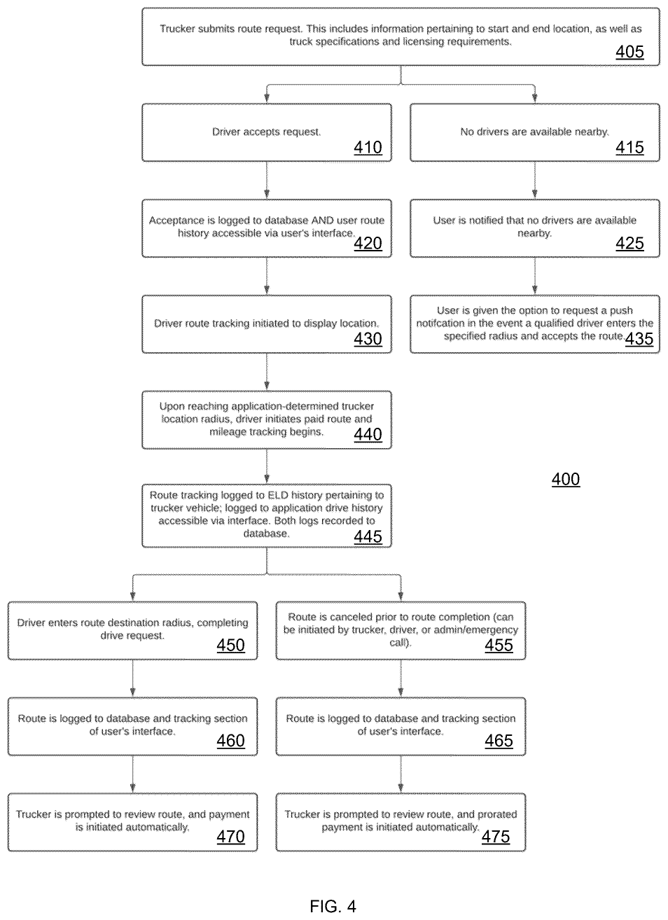

Delivery-route requests can be submitted by Providers. Upon submission, Drivers having required qualifications as specified by the Provider and within a Provider-specified and predetermined radius, if available, are notified of the route request. Upon receiving this notification, Drivers reviewing the application are presented with route details and given the option to accept or decline the route request. The route can thus be initiated when the first notified Driver accepts the drive request. The route tracking and logging flow is shown in and discussed below with reference to FIGS. 3 and 4 from the points of view of the Driver and Provider, respectively.

Upon successful completion of the delivery route, the Provider is presented with an option to rate the Driver (e.g., 1 to 5 stars). This information is logged to the database 240 and displayed on the Driver's profile. Upon termination or completion of the route, the application calculates the final amount due to the Driver from the Provider. This amount is paid via, for example, the Stripe API and then distributed between the Driver and, in an embodiment, administrator payment receiving accounts.

In an embodiment, one or more of the applications may utilize the Angular framework to render front-end components and interactions. For IOS, the Swift programming language may render the application; for Android, the Java programming language may render the application.

The database 240 used for one or more of the applications stores data pertaining to Drivers, Providers, and the administrator across separate collections which may be fetched by the application/differing schema as needed. These collections may include route data, user and administrator profile data, transaction and payout history-all interactions logged to the database 240 by the application. Databases may be written in JavaScript for MongoDB. Data may be appended/removed/updated according to application-programmed interactions triggered by users, administrators, and/or developed automations.

Profile data and route data may be submitted to/retrieved from the server 230 through the users' mobile applications via one or more client devices 270 and securely encrypted.

Profile data may be submitted/modified via the web application dashboard on one or more client devices 270. However, in an embodiment, route information may not be tracked using the web application. One purpose of this application is to view historical data and download any necessary records.

Push notifications may be sent to users for the purpose of delivering various reminders, including drive requests, notifications of available Drivers, marketing messages and more.

Users may be allowed to communicate via in-app messaging during the Driver's initial route to arrive at the Provider's location for the purpose of clarifying location specifications or managing issues with locating the other.

There can be an emergency contact section of the application which may be used to alert local authorities in the event of an emergency. There can also be the option for each user to input their own emergency contact for quick access via the application. Technical/Customer support inquiries initiated within the app can be directed to the user's default SMTP email client.

Users may register a Provider or Driver account via, for example, email, Google, or Facebook. Application invitations may be sent with an invitation link through the app. Users can be prompted to select a Username as identification, as well, to be associated with their account. This information is stored and related within the database 240. In addition, required documentation (government-issued identification) can be stored to each user's profile on the back-end (not publicly visible and securely encrypted).

FIG. 3 illustrates a process 300, according to an embodiment of the invention, for route tracking and logging flow from the point of view of the Driver to achieve the objectives of the invention discussed above herein. The process 300 is illustrated as a set of operations shown as discrete blocks. One or more steps of the process 300 may be implemented in any suitable hardware, software, including instructions embodied within components, firmware, or combination thereof and enabled by data calls to database 240 from one or more of client device 270, server 230 and computer system 260. The order in which the operations associated with the process 300 are described is not to be necessarily construed as a limitation.

At a step 305, a dashboard/push notification of a Provider request is submitted to a Driver via the Driver's client device 270 such as that illustrated in FIG. 2. In an embodiment, the request from the Provider is for the Driver to travel to a source destination designated by the Provider and retrieve an item at the source destination for the Driver to deliver to a target destination. In an embodiment, the Provider provides a vehicle at the source destination for the Driver to use to deliver the item to the target destination. The request can include the source destination, target destination and/or route information to inform the Driver's decision to accept or reject the route request.

At a step 315, the Driver may decide to decline the request. If so, process 300 moves to step 325 wherein the Driver is redirected to the Driver dashboard. The request decline is logged to database 240 but not necessarily to the Driver's viewable interface or job history.

At a step 310, the Driver can choose to accept the request. If so, at a step 320 this acceptance is logged to database 240, and the Driver job history accessible via the Driver's interface with the application.

At a step 330, Driver route tracking is initiated to display the source destination.

At a step 335, and in an embodiment, upon reaching a predetermined distance from the source destination, the Driver initiates the paid route and mileage tracking begins. Alternatively, the route tracking commences automatically upon the Driver reaching such predetermined distance.

At a step 340, route tracking is logged to a history file of an electronic logging device (ELD) associated with the vehicle used by the Driver to deliver the item, as well as to an application drive history that may be stored, for example, in the Driver's client device 270 and accessible via the application interface. Both of these logs can be recorded to database 240.

At a step 345, the Driver reaches a predetermined distance from the target destination, completing the requested item delivery. Process 300 then proceeds to a step 355 in which the route is logged to database 240 and a tracking section of the Driver's application interface. Review of a rating of the Driver's performance is available once it is submitted by Provider.

Alternatively, at a step 350 the route is cancelled prior to item delivery. This cancellation can be initiated by the Provider, Driver, administrator or because of an emergency call. Process 300 then proceeds to a step 360 in which the route is logged to database 240 and tracking section of the Driver's application interface. Review of a rating of the Driver's performance is available once submitted by the Provider.

FIG. 4 illustrates a process 400, according to an embodiment of the invention, for route tracking and logging flow from the point of view of the Provider to achieve the objectives of the invention discussed above herein. The process 400 is illustrated as a set of operations shown as discrete blocks. One or more steps of the process 400 may be implemented in any suitable hardware, software, including instructions embodied within components, firmware, or combination thereof and enabled by data calls to database 240 from one or more of client device 270, server 230 and computer system 260. The order in which the operations associated with the process 400 are described is not to be necessarily construed as a limitation.

At a step 405, the Provider submits a route request via server 230, which is made available for review to all Drivers who have a client device 270 configured to access an account in communication with the server according to an embodiment. In an embodiment, the request from the Provider is for the Driver to travel to a source destination designated by the Provider and retrieve an item at the source destination for the Driver to deliver to a target destination. In an embodiment, the Provider provides a vehicle at the source destination for the Driver to use to deliver the item to the target destination. In an embodiment, the request is provided only to Drivers located within a predetermined distance of the source destination, as may be determined by the server 230 using, for example, GPS or other geolocation-type signals produced by the Drivers' client devices 270. The request can include the source destination, target destination and/or route information, as well as truck specifications and licensing requirements.

At a step 415, server 230 determines that no Drivers that meet the requirements described at step 405 are available. Process 400 then proceeds to step 425 in which the Provider application is notified by server 230 that no Drivers are available nearby. Process 400 then proceeds to step 435 in which the Provider is given the option to request a push notification from server 230 in the event a Driver meets the requirements described at step 405 and accepts the route.

Alternatively, at a step 410, a Driver meeting the requirements described at step 405 accepts the request. Process 400 then proceeds to step 420 in which the acceptance of the request is logged to database 240, and the user route history is accessible via the Provider's interface with the application. Process 400 then proceeds to step 430 in which the Driver route tracking is initiated to display to the Driver the source destination, target destination and/or route information.

At a step 440, upon reaching a predetermined distance from the source destination, as may be determined by the server 230 using, for example, GPS or other geolocation-type signals produced by the Drivers' client devices 270, the Driver initiates the paid route and mileage tracking begins. Alternatively, the route tracking commences automatically upon the Driver reaching such predetermined distance.

At a step 445, route tracking is logged to a history file of an electronic logging device (ELD) associated with the vehicle used by the Driver to deliver the item, as well as to an application drive history that may be stored, for example, in the Driver's client device 270 and accessible via the application interface. Both of these logs can be recorded to database 240.

At a step 450, the Driver reaches a predetermined distance from the target destination, as may be determined by the server 230 using, for example, GPS or other geolocation-type signals produced by the Drivers' client devices 270, completing the requested item delivery. Process 400 then proceeds to a step 460 in which the route is logged to database 240 and a tracking section of the Provider's application interface. Process 400 then proceeds to step 470 in which the Provider is prompted to review the route, and payment to the Driver who completed the route is initiated automatically.

At a step 455, the route is cancelled prior to route completion. This cancellation can be initiated by the Provider, Driver, administrator or because of an emergency call. Process 400 then proceeds to a step 465 in which the route is logged to database 240 and a tracking section of the Provider's application interface. Process 400 then proceeds to step 475 in which the Provider is prompted to review the route, and a prorated payment, for example, to the Driver who completed the route is initiated automatically.

One or more embodiments may include the following features:

Stripe Payment API is integrated for handling and disbursing payments.

Google/Facebook login enabled via API integration.

Google Analytics tracking API is integrated for the purpose of analyzing user demographics and behavior as well as informed bug reporting.

Termly.io API integration allows for auto-updating Cookies, Terms & Conditions, Privacy Policy, and Disclaimer—only renders formatted text snippets of these files.

Google Cloud Server securely stores application data.

The application can be uploaded to the Google Play and Apple IOS stores for public distribution upon beta testing and launch.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. At least one computer-readable medium on which are stored instructions that, when executed by one or more processing devices, enable the one or more processing devices to perform a method of facilitating delivery of an item from a source destination to a target destination, the method comprising the steps of:
receiving over a network a delivery-route assignment request from a first user device associated with a producer;
transmitting the request over the network to one or more vehicle drivers;
receiving over the network an acceptance of the request from a second user device associated with a vehicle driver;
receiving over the network a first signal indicating that the vehicle driver is a predetermined first distance from the source destination;
receiving over the network a second signal indicating that the vehicle driver is a predetermined distance from the target destination; and
in response to receiving the second signal, authorizing over the network a payment to the vehicle driver.

2. The medium of claim 1, wherein the method further comprises determining if the one or more drivers are within a predetermined second distance from the source destination, the second distance being larger than the first distance.

3. The medium of claim 2, wherein the method further comprises transmitting the request only to the one or more drivers who are within the predetermined second distance from the source destination.

4. The medium of claim 2, wherein the method further comprises notifying the producer once a driver is within the second distance and accepts the request.

5. The medium of claim 1, wherein the request includes identification of driver licensing requirements to accept the request.

6. A system, comprising:
one or more processing devices;
and at least one memory on which are stored instructions that, when executed by the one or more processing devices, enable the one or more processing devices to perform a method of facilitating delivery of an item from a source destination to a target destination, the method comprising the steps of:
receiving over a network a delivery-route assignment request from a first user device associated with a producer;
transmitting the request over the network to one or more vehicle drivers;
receiving over the network an acceptance of the request from a second user device associated with a vehicle driver;
receiving over the network a first signal indicating that the vehicle driver is a predetermined first distance from the source destination;
receiving over the network a second signal indicating that the vehicle driver is a predetermined distance from the target destination; and
in response to receiving the second signal, authorizing over the network a payment to the vehicle driver.

7. The system of claim 6, wherein the method further comprises determining if the one or more drivers are within a predetermined second distance from the source destination, the second distance being larger than the first distance.

8. The system of claim 7, wherein the method further comprises transmitting the request only to the one or more drivers who are within the predetermined second distance from the source destination.

9. The system of claim 7, wherein the method further comprises notifying the producer once a driver is within the second distance and accepts the request.

10. The system of claim 6, wherein the request includes identification of driver licensing requirements to accept the request.
